(19) United States
(12) Patent Application Publication
(10) Pub. No.: US 2026/0048520 A1
(43) Pub. Date: Feb. 19, 2026

(54) SHAVING DEVICE

(71) Applicants: Papacks Sales GmbH, Koeln (DE); Wilkinson Sword GmbH

(72) Inventors: Tahsin Dag, Koeln (DE); Matthias Niggemann, Solingen (DE); Andreas Toens, Solingen (DE)

(73) Assignees: Papacks Sales GmbH, Koeln (DE); Wilkinson Sword GmbH, Solingen (DE)

(21) Appl. No.: 19/104,427

(22) PCT Filed: Aug. 15, 2023
(86) PCT No.: PCT/EP2023/072467

§ 371 Date: Feb. 18, 2025

(30) Foreign Application Priority Data
Aug. 16, 2022 (DE) 10 2022 120 574.6

(51) Int. Cl. B26B 21/52; D21J 5/00

(52) U.S. Cl. CPC B26B 21/528; B26B 21/521; D21J 5/00

(57) ABSTRACT

A shaving device includes a handle attached to a razor head carrying at least one razor blade. The handle is a molded fiber part having an elongated hollow body open on one side. The shaving device may also include reinforcing elements arranged in the elongated hollow body that forms the handle, a plurality of reinforcing ribs spaced apart from one another and traversing the elongated hollow body of the handle in a transverse direction with respect to the handle, reinforcing ribs that completely fill a U-shaped cross-section of the elongated hollow body of the handle, reinforcing ribs having a height that is significantly less than a height of the handle, and/or at least one longitudinal rib in the elongated hollow body of the handle. The molded fiber part may include a mixture of long fibers, short fibers and microfibrils. The fiber blend may have a mixture of hemp fibers.

### TECHNICAL FIELD

This application relates to a shaving device having a handle and a razor head attached to the handle, the razor head carrying at least one razor blade.

### BACKGROUND ART

Wet razors are provided as disposable razors or system razors. Disposable razors are disposed of after the razor blade wears out. System razors have replaceable razor heads, so that the handle is used over a longer period of time and the razor head is replaced. Furthermore, hybrid razors are offered which, like system razors, have replaceable razor heads but generally have a shorter life span than system razors.

WO 2017/003919 A1 discloses a razor with a handle in which a fluid dispenser is arranged. The handle of the razor can be made of single-ply or multi-ply cardboard. Handling, cutting and processing of cardboard is laborious, and it is problematic to obtain an attractive shape. US 2016/0325445 A1 discloses a device for supporting razor heads to be mounted to a handle generally described as a rod. Another razor head adapter is disclosed by US 2017/0087733 A1. Wo 2022/049258 A2 discloses personal care products with rod shaped, tube shaped or flat handles made of paper material.

### SUMMARY OF INVENTION

It is desirable to provide an environmentally sustainable razor that is easy to manufacture and has a favorable design.

In a system described herein, a handle of a razor is a molded fiber part having an elongated hollow body open on one side.

The production of molded pulp parts by sucking pulp fibers from an aqueous fiber pulp using a suction mold is known. Originally, egg cartons and beer coasters were produced using this technique. More recently, complex shaped packaging elements, e.g., disclosed in EP 3 310 673 B1, are manufactured from pulp as molded fiber parts.

In the system described herein, the handle of a razor is manufactured as a molded fiber part. Compared to manufacturing from cardboard or paperboard, manufacturing the handle of a razor as a molded fiber part has the advantage that the shape of the handle can be adapted to the intended use and the mechanical loads. In particular, the outside of the handle can have a pleasantly curved surface that is easy to grip and to use.

The handle is formed by an elongated hollow body open on one side. The handle has the form of an elongated shell that is easy to produce from molded pulp. The outer surface of the elongated shell may follow a U-shape in the transverse direction and rest in the palm of the user when the razor is used. In the longitudinal direction, the outer surface of the elongated shell may be straight or slightly curved so that the elongated shell pleasantly rests in the palm of the user when the razor is used.

In some embodiments, reinforcing elements may be arranged in the open elongated hollow body that forms the handle. In other words, the hollow and open elongated shell that forms the handle may include multiple reinforcing elements projecting from the inner surface towards the opening. The reinforcing elements provide structural stability to the elongated hollow shell. The reinforcing elements may also serve as spacers between two elongated hollow shell nested in one another, for example during a coating or drying treatment. In some embodiments, the elongated hollow body that forms the handle may be traversed in a transverse direction by a plurality of mutually spaced reinforcing ribs. As mentioned above, the hollow body preferably has a U-shaped cross-section. The reinforcing ribs may follow the U-shape and extend approximately 1 or 2 mm into the cavity formed by the open elongated hollow body. As an alternative, the reinforcing ribs may completely fill the U-shaped cross-section. In this way, the handle made of fibers obtains considerable stability. Reinforcing ribs are easy to manufacture using molded pulp. However, the reinforcing elements inside the cavity of the shell may have different shapes and do not necessarily have to extend in the transverse direction. For example, projections in the form of oval or round tubes may be arranged inside the hollow shell and extend from the inner wall of the hollow shell towards the opening.

The razor head with the razor blade(s) may be attached directly to the handle. In an alternative embodiment, the razor head may be attached to an adapter piece, which in turn is attached to the handle.

In particular, the adapter piece may have at least one of the following features:
a hollow receptacle into which an end portion of the handle is inserted;
an attachment portion to which the razor head is pivotally attached.

In other words, the receptacle of the adapter piece is designed as a cavity open on one side and the end section of the handle is inserted through the opening of the receptacle. In some embodiments, the cavity may be shaped complementary to the end portion of the handle. The razor head can be detachably and pivotally attached to an attachment portion. In this manner, the razor is provided with replaceable razor heads that can be changed when the razor blades become dull.

In some embodiments, the adapter piece can also be made of a biodegradable thermoplastic. Such a biodegradable thermoplastic may in particular include starch and, as further constituents, glycerol and sorbitol as plasticizers. In particular, 11-15 wt % glycerol and 6-9 wt % sorbitol based on the total weight of the material in the dried state have proven to be advantageous. In this case, the concentration of starch is between 56 and 63 wt %. Other ingredients may be fillers in concentrations of 12-24 wt %. The fillers can be talc, chalk, bentonite, mustard seed hulls, organic fibers or waste materials. The thermoplastic material can be excellently processed in twin-screw extruders and injection molded. The thermoplastic material can be made moisture resistant and with considerable hardness by applying appropriate coatings. Furthermore, the thermoplastic material is biodegradable or bioinert. Therefore, like the handle of the razor, the thermoplastic material can be disposed of without hesitation.

In some embodiments, the end portion of the handle and the receptacle of the adapter piece can be glued together. This allows achieving the necessary stability of the razor.

In some embodiments, the width of the handle may increase from the first end near the razor head to the free end of the handle. The relatively narrow first end of the handle may be inserted into the hollow receptacle of the adapter piece. The wider free end of the handle rests in the palm of the user's hand during use, allowing for large area force transfer. This provides a secure grip and comfortable use of the handle.

In some embodiments, the handle may have on its top at least one of the following:
a circular recess near an insertion portion at one end of the handle;
at least one and preferably two curved beads.

The indentation can mark the optimal point of pressure application during shaving. The beads can increase the stiffness and grip of the handle.

For example, the circular depression and/or the curved bead can be formed directly in the suction mold. For this purpose, the suction mold can have raised areas on a porous suction surface of the suction mold that form the beads or the depression. In another embodiment, the circular depression and/or the curved bead can be embossed into the surface of the handle during a subsequent pressing process after forming in the suction mold. The pressing process additionally compacts and strengthens the material of the handle in the region of the indentation and/or the bead.

In some embodiments, the molded fiber part that forms the handle may have a mixture of long fibers, short fibers and microfibrils. The long fibers having a length of more than 1.5 mm provide the handle with considerable stability. Short fibers of 0.5-1.5 mm fill the spaces between the long fibers. Microfibrils with a length of 20-70 μm fill the pores between the short fibers. The fiber lengths apply to a handle made of conventional cellulose fibers. When hemp fibers are used, the long fibers can have a length of 2.5 mm and the short fibers can have a length of 1-2.5 mm. The microfibrils also preferably have a length of less than 100 μm when hemp fibers are used.

In some embodiments, the molded fiber part may be coated with at least one coating. A coating with at least one lipid, such as linseed oil, a wax, such as beeswax and carnauba wax, and/or also alkyl ketene dimers (AKD), provides the molded fiber part with water resistance. A silicate coating, i.e. a coating with silica gel (silicon dioxide—SiO₂), provides the molded fiber part with increased stability. Preferably, the molded fiber part receives a primer of carnauba wax so that the molded fiber part is dimensionally stable even at high temperatures. A second coating contains lipids and silicon dioxide. This increases resistance to moisture on the one hand and mechanical stability on the other.

The adapter piece may include, in a known manner, a latching device for releasably connecting the razor head so that the razor head may be changed when the razor blades are dull.

The razor head may include an injection molded support element to which the razor blades are attached. In some embodiments, the support element may also be made of a biodegradable thermoplastic, such as the starch-based thermoplastic described above.

A suction mold having a plurality of rib-like elongated projections is used for the production of the handle of a razor described above. The suction mold is dipped in a pulp, and the pulp is sucked through openings in the surface of the rib-like projections. The surface of the rib-like protrusions may be screen-like and lattice-like, or may be made of a porous material so as to have a plurality of uniformly distributed openings through which the water in the pulp can be sucked out. The fibers from the pulp are deposited on the surface of the rib-like protrusions so that a molded fiber part is formed on each rib-like protrusion, which forms the handle of the razor. Multiple handles are formed in a single manufacturing step. Each rib-like protrusion may have transverse depressions along a length of each rib-like protrusion in which the transverse reinforcing ribs of the molded fiber part are deposited.

In some embodiments, a transfer mold with cavities complementary to the rib-like projections can be used to remove the molded fiber parts from the ribs. The transfer mold is pressed against the suction mold in such a way that the rib-like projections with the fiber castings formed thereon lie in the associated cavities of the transfer mold. The surface of the cavities of the transfer mold also has openings through which a negative pressure can be generated in the cavities. When the transfer mold is pressed onto the suction mold, water is pressed out of the fiber mold body. Further water is sucked out through the openings of the transfer mold. The fiber moldings are thus dehydrated and stabilized. The transfer mold can be used to remove the fiber castings from the suction mold and transport the fiber castings to further processing stations. The further processing stations can include, for example, a drying oven in which the molded fiber parts are dried by heating. Further, the molded fiber parts may be fed to a coating station in which the molded fiber parts are coated. If coating of the outer surface is desired, the molded fiber parts may either be coated in the suction mold or removed from the transfer mold prior to coating. Finally, the molded fiber parts can be fed to a stamping die in which the fiber castings are stamped out to a final shape. The molded fiber parts may also be fed to a pressing die, in which the parts are pressed and thereby further hardened and dewatered. It should be noted that the sequence of processing steps can be changed. For example, the molded fiber parts can also be coated after stamping.

### BRIEF DESCRIPTION OF DRAWINGS

Further practical embodiments and advantages of the device described herein and a production process of the device described herein are set forth below in connection with the drawings.

FIG. 1 shows a three-dimensional exploded view of an embodiment of a razor viewed from above.

FIG. 2 shows a three-dimensional view of a handle of the razor of FIG. 1 viewed from above.

FIG. 3 shows a three-dimensional view of the handle of FIG. 2 viewed from below.

FIG. 4 shows a longitudinal section of the handle of FIG. 2.

FIG. 5 shows a top view of the handle of FIG. 2.

FIG. 6 shows a sectional view of the handle according to section line VI-VI in FIG. 5.

FIG. 7 shows a three-dimensional view of a suction mold for manufacturing the handle of FIG. 2-6.

FIG. 8 shows a three-dimensional view of a transfer mold for manufacturing the handle of FIG. 2-6.

FIG. 9 shows a three-dimensional view of a second embodiment of a handle viewed from below.

FIG. 10 shows a bottom view of the handle of FIG. 9.

FIG. 11 shows a three-dimensional view of a third embodiment of a handle viewed from below.

FIG. 12 shows a bottom view of the handle of FIG. 11.

### DESCRIPTION OF EMBODIMENTS

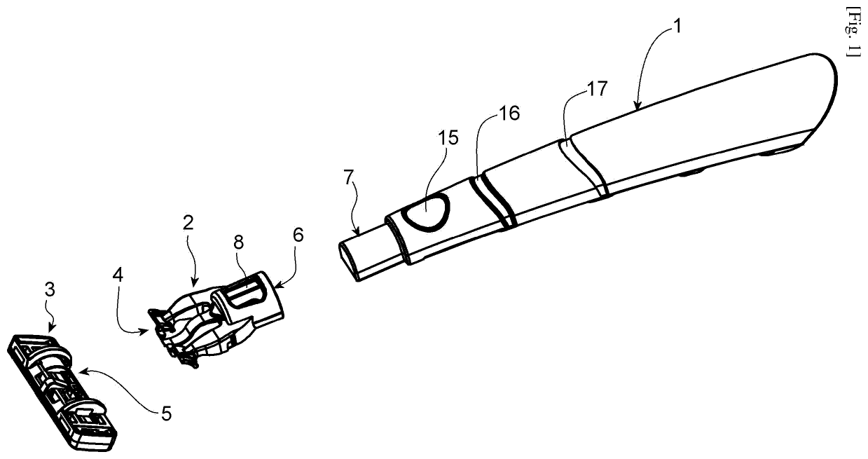

Referring to FIG. 1, the razor is shown as consisting of a handle 1 formed by a molded part made of molded fiber, an injection-molded adapter piece 2, and a razor head 3. The razor head 3 consists of a support element made of injection-molded thermoplastic to which razor blades are attached. The razor blades are located on the underside of the razor head 3, which is not visible in FIG. 1. The adapter piece 2 is also made of injection-molded thermoplastic. The adapter piece 2 has a latching device 4 which cooperates in a known manner with a complementary latching device 5 on the razor head 3. The latching device 4 forms an attachment portion for the razor head 3. The razor head 3 is pivotably fastened to the adapter piece 2 using the latching devices 4, 5.

In the case of a disposable razor, the adapter piece 2 may be directly and optionally rigidly connected to the razor head 3.

The adapter piece 2 has a hollow receptacle 6 on a side of the adapter piece 2 that is opposite the latching device 4, which is essentially in the form of an open tube section. An insertion portion 7 is inserted through the free, open end of the hollow receptacle 6 at one end of the handle 1. The hollow receptacle 6 has a clear cross-section substantially corresponding to the cross-section of the insertion portion 7 of the handle 1. On the upper side, the hollow receptacle 6 has a window-like opening 8.

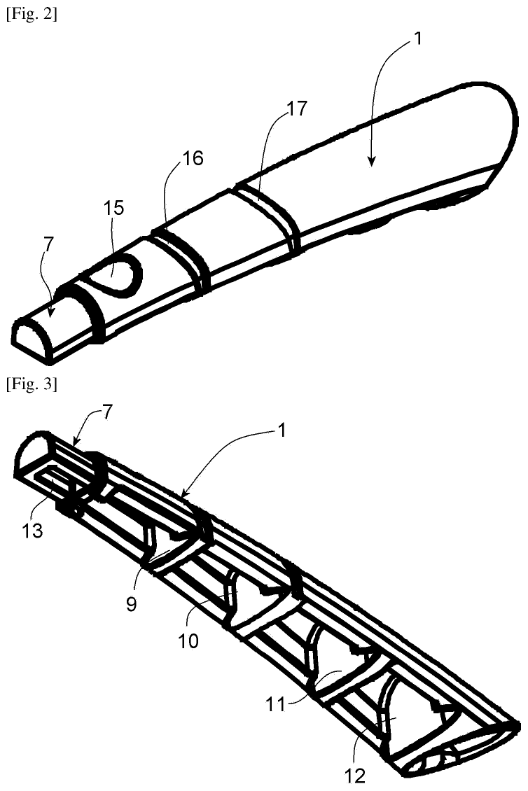

As can be seen in FIG. 3, the handle 1, which is made of molded fiber, consists of a closed and curved upper surface, the cross-section of which is essentially in the shape of an inverted U. The shape of the wall of the handle can be seen in particular in FIG. 6.

Hence, the handle 1 consists of a hollow body open on one side, the open side of the hollow body being at the bottom. The essentially U-shaped, elongated hollow body can be traversed by several spaced-apart reinforcing ribs 9, 10, 11, which give the handle 1 the required stability.

The insertion portion 7 of the handle 1 is also hollow in order to provide the insertion portion 7 with a certain degree of flexibility and to enable the insertion portion 7 to be reliably manufactured using the fiber molding process. The insertion portion 7 has a cavity 13 which extends from the bottom upwards, as can be seen in FIG. 4.

On an upper side, the handle 1 has a circular depression 15 near the insertion portion 7, which marks a point on which the user preferably applies a pressure force in order to achieve an optimal pressing of the blades of the razor head 3 against the skin. Furthermore, the handle 1 has two curved beads 16, 17 on an upper side of the handle 1. The circular depression 15 and the beads 16, 17 can either already be formed in the suction mold or can be embossed into the surface of the handle 1 during a later pressing process. Embossing has the advantage that the material of the handle 1 is additionally compacted and strengthened. The beads 16, 17 provide the surface of the handle 1 with an increased grip. The width of the handle 1 increases from an end near the adapter piece 2 to a free end of the handle 1. The handle 1 thus obtains the required stability and is pleasant to hold and use.

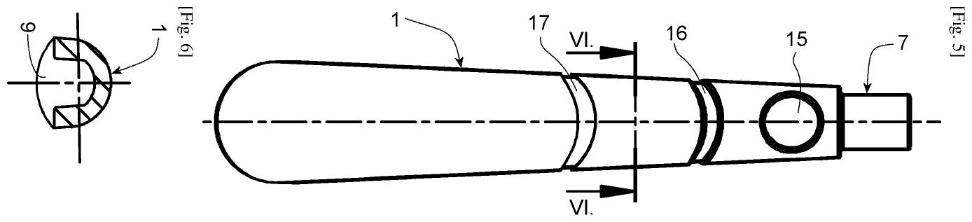

The handle 1 is formed in a fiber molding process by dipping a suction mold 18, the surface of which is formed complementary to the underside of the handle 1, into a basin with pulp. The suction mold 18 shown in FIG. 7 has ten rib-like projections 19 parallel to each other, the surface of each of the projections 19 being formed complementary to the side of the handle 1 facing downward in FIGS. 1 and 2. In this way, ten reproductions of the handle 1 can be manufactured simultaneously with the suction mold 18. It can be seen that each rib-like projection 19 of the suction mold 18 has three transversely extending recesses 20, 21 and 22. Only the recesses 20-22 of the rib-like projections 19 extending along the right edge of the suction mold 18 in FIG. 7 are provided with reference signs. Fiber material is deposited in the recesses 20-22 during the suction of the pulp, which forms the reinforcing ribs 9, 10, 11 of the handle 1. The last reinforcing rib 12 is deposited on the axial end surface of the rib-like projections 19.

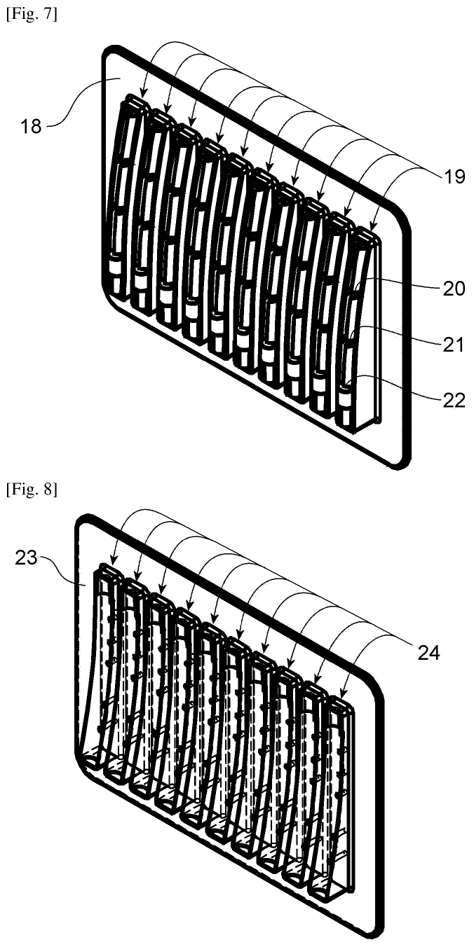

When a fiber layer of sufficient thickness has been deposited on the rib-like projections 19 of the suction mold 18 by suction over an appropriate period of time, the suction mold 18 is removed from the pulp. The sucked fiber material can now be pressed and compacted. In FIG. 8, a transfer mold 23 can be seen which has cavities 24 complementary to the rib-like projections 19 of the suction mold 18. The transfer mold 23 is pressed against the fiber castings deposited on the rib-like projections 19 of the suction mold 18, thus causing dewatering. In addition, the transfer mold 23 also includes suction channels that open into openings in the surface of the cavities 24 and allow the fiber castings to be sucked to the transfer mold 23 to further dewater and remove the fiber castings from the suction mold 18. The transfer mold 23, with the molded fiber parts received therein, may be transported through a drying oven in which the molded fiber parts are dried. Preferably, the molded fiber parts may be coated prior to drying.

As mentioned above, the coating preferably has waxes, lipids and glues such as alkyl ketene dimers. These ingredients increase mechanical strength and water resistance. A further coating of silica gel may be applied to provide the strength required for use as a razor handle. In some embodiments, a primer of carnauba wax is preferably applied as the first coating. Carnauba wax has a high melting temperature and imparts the required hardness to the molded fiber parts. In a second coating, the molded fiber parts can be coated with lipids to increase resistance to water. Silica gel can be included in the second coating, as mentioned, which increases both water resistance and dimensional strength.

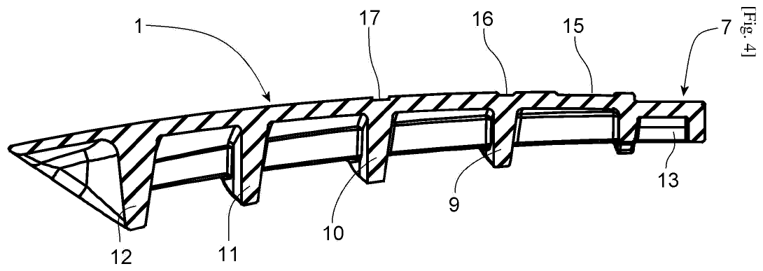

Further processing steps for the molded fiber parts may include punching and embossing. A stamping tool can be used to cut the molded fiber parts to shape to provide a uniform shape of the handles 1 as shown in FIGS. 1 to 6. An additional stamping tool can be used to stamp the circular recess 15 and the beads 16, 17 into the surface of the handle 1.

As an alternative, two molds similar to the molds 18 and 23 may be used for producing handle using a pulp compression molding process. Pulp compression molding forms parts out of pulp slurry instead of liquified pulp. A given quantity of mushy pulp slurry is provided to the cavities of a negative or female mold that may have a shape like mold 23 in FIG. 8. The positive or male mold that may have a shape like mold 18 in FIG. 7 is aligned to and pressed against the negative mold and the pulp slurry is compressed and distributed evenly throughout the cavity of the negative mold. When the compression process is finished, a thin space is formed between the surface of cavities the female mold and the surface of the projections of the male mold, the thin space corresponding in shape to the shape of the handle to be formed. The water is pressed out of the pulp slurry and the resulting molded fiber part may be dried for use as a handle. The resulting molded fiber part may be coated. Alternatively, additives that help obtaining the needed rigidity and physical properties of the molded fiber part for use as a razor handle may be added to the pulp slurry before the compression step.

FIG. 9 and FIG. 10 show a second embodiment of a razor handle 1′. Like the first embodiment, the handle 1′ consists of an elongated shell or hollow body with a U-shaped cross-section, open at one side, in FIG. 9 the bottom side. Four spaced-apart reinforcing ribs 9′, 10′, 11′ and 12′ are evenly distributed over the length of the handle 1′. In contrast to the ribs 9, 10, 11, 12 of the first embodiment, the reinforcing ribs 9′, 10′, 11′ and 12′ of the handle 1′ do not completely fill the U-shaped cross-section of the handle 1′ but have a height that is significantly less than the height of the handle 1′. The transverse reinforcing ribs 9′, 10′, 11′ and 12′ extend from the inner or lower (FIG. 9) surface of the open and hollow handle 1′ and follow the U-shape of the inner surface. The reinforcing ribs 9′, 10′, 11′ and 12′ extend approximately 1 or 2 mm into the cavity formed by the open elongated hollow body of the handle 1′. The reinforcing ribs 9′, 10′, 11′ and 12′ strengthen the structure of the handle 1′ and avoid a surface contact of two reproductions of the handle 1′ nested into one another, for example, during drying or coating.

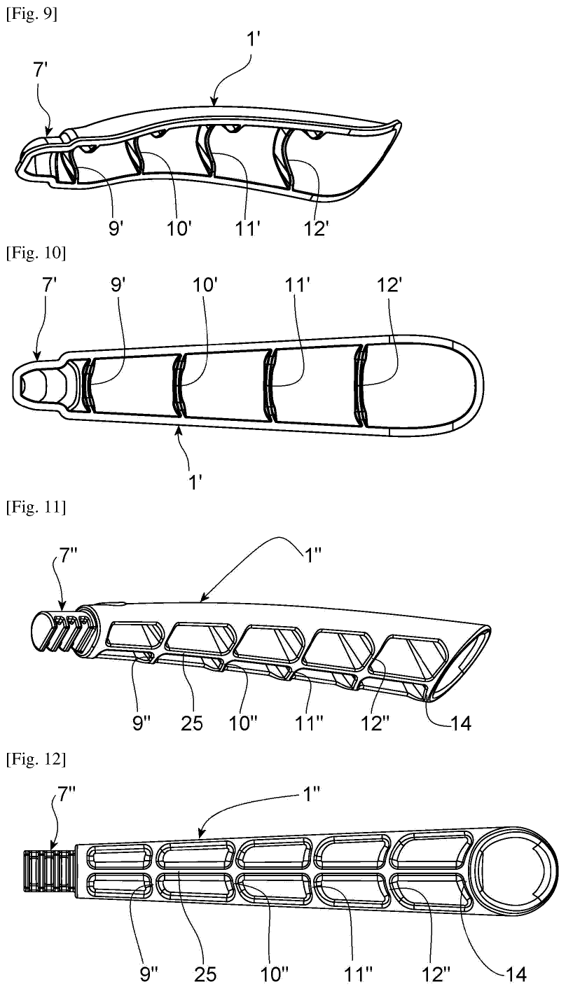

FIG. 11 and FIG. 12 show a third embodiment of a razor handle 1″. Again, the handle 1″ has an elongated shell or hollow body with a U-shaped cross-section, open at one side, in FIG. 11 the bottom side. The handle 1″ has five evenly spaced reinforcing ribs 9″, 10″, 11″, 12″, 14 and a longitudinal rib 25 extending in the longitudinal plane of symmetry of the handle 1″. The longitudinal rib 25 reduces the risk of buckling of the handle 1″ when the razor head fixed to an end of the handle 1″ is firmly pressed against the skin. At the crossing points, the reinforcing ribs 9″, 10″, 11″, 12″, 14 merge into the longitudinal rib 25. The shell-like hollow body of the razor handle 1″ is partitioned into ten small compartments open at the bottom. The rib-like projections on the mold for producing the handle 1″ have corresponding gaps or grooves for forming the ribs. Due to the gaps or grooves, the molded fiber part forming the handle 1″ may adhere to the mold. It may be helpful to apply pressurized air to the mold which flows through the porous walls of the rib-like projections and blows the molded fiber part off the mold.

The features of the device disclosed in the present description, in the drawings as well as in the claims may be essential, both individually and in any combination, for the realization of the device in its various embodiments. The invention is not limited to the embodiments described. The invention may be varied within the scope of the claims and with due regard to the knowledge of the person skilled in the art.

1. A shaving device, comprising:
a handle; and
a razor head adapted to be attached to the handle and to carry at least one razor blade, wherein the handle is a molded fiber part having an elongated hollow body open on one side.

2. The shaving device according to claim 1, wherein the handle further includes at least one of the following:
reinforcing elements arranged in the elongated hollow body that forms the handle;
a plurality of reinforcing ribs spaced apart from one another and traversing the elongated hollow body of the handle in a transverse direction with respect to the handle;
reinforcing ribs that completely fill a U-shaped cross-section of the elongated hollow body of the handle;
reinforcing ribs having a height that is significantly less than a height of the handle;
at least one longitudinal rib in the elongated hollow body of the handle.

3. The shaving device, according to claim 1, wherein the razor head is attached to the handle using an adapter piece that is disposed between the razor head and the handle.

4. The shaving device according to claim 1, wherein an upper side of the handle includes at least one of the following:
a circular recess near an insertion portion at one end of the handle; or
at least one curved bead.

5. The shaving device according to claim 4, wherein the circular depression and/or the curved bead are formed in a suction mold.

6. The shaving device according to claim 4, wherein the circular depression and/or the curved bead are embossed into a surface of the handle during a subsequent pressing operation after forming in a suction mold, and wherein material of the handle is additionally compacted and solidified in a region of the depression and/or the bead.

7. The shaving device according to claim 1, wherein the molded fiber part includes a mixture of long fibers, short fibers and microfibrils.

8. The shaving device according to claim 7, wherein the molded fiber part forming the handle has at least one of the following features:
the long fibers have a length of over 1.5 mm and give the handle considerable stability;
the short fibers have a length of 0.5-1.5 mm and fill the spaces between the long fibers;
the microfibrils have a length of 20-70 μm and fill the pores between the short fibers; or
the fiber blend has a mixture of hemp fibers in which the long fibers have a length of 2.5 mm, the short fibers have a length of 1-2.5 mm, and the microfibrils have a length of less than 100 μm.

9. The shaving device according to claim 1, wherein the molded fiber part is coated with at least one coating.

10. The shaving device according to claim 9, wherein the coating includes at least one of the following ingredients:
waxes;
lipids;
alkyl ketene dimers (AKD); or
SiO₂.

11. The shaving device according to claim 10, wherein the handle is first coated with a primer of carnauba wax and then with a further coating containing lipids and SiO₂.

12. The shaving device according to claim 3, wherein the adapter piece has a latching device configured to be releasably connected to the razor head.

13. The shaving device according to claim 1, wherein the razor head includes a support element made of a biodegradable thermoplastic to which the at least one razor blade is attached.

14. A method of manufacturing a handle of a razor, comprising:
dipping a suction mold having a plurality of rib-like projections in a pulp; and
sucking the pulp through openings in a surface of the rib-like projections so that a fiber casting molding is deposited on each of the rib-like projections to form the handle of the razor.

15. The method according to claim 14, further comprising:
pressing a transfer mold having cavities complementary to the rib-like projections against molded fiber parts formed on the rib-like projections; and
applying a negative pressure to openings in a surface of the cavities so that the molded fiber parts are removed from the suction mold with the transfer mold.

16. A method of manufacturing handles of razors, comprising:
applying pulp slurry between a first mold having a plurality of rib-like projections and a second mold having cavities complementary to the rib-like projections; and
pressing the first mold and the second mold against each other so that a molded fiber part is formed on each of the rib-like projections to form the handles of the razors.
